(19) United States
(12) Patent Application Publication
(10) Pub. No.: US 2023/0151214 A1
(43) Pub. Date: May 18, 2023

(54) SULFUR-CROSSLINKABLE RUBBER-COATING MIXTURE

(71) Applicant: Continental Reifen Deutschland GmbH, Hannover (DE)

(72) Inventors: Christoph Eichhorst, Hanau (DE); Vipin Rajan, Ronnenberg (DE); Cornelia Schmaunz-Hirsch, Wunstorf (DE); Thomas Kramer, Herford (DE); Carla Recker, Hannover (DE)

(73) Assignee: Continental Reifen Deutschland GmbH, Hannover (DE)

(21) Appl. No.: 17/995,108

(22) PCT Filed: Dec. 1, 2020
(86) PCT No.: PCT/EP2020/084077

§ 371 Date: Sep. 29, 2022

(30) Foreign Application Priority Data
Mar. 31, 2020 (DE) 10 2020 204 151.2

(51) Int. Cl. C08L 75/08; C08L 61/28; B60C 1/00; C08K 5/47

(52) U.S. Cl. CPC C08L 75/08; C08L 61/28; B60C 1/0041; C08K 5/47; C08K 2003/0843

(57) ABSTRACT

The invention relates to a sulfur-crosslinkable rubberization mixture for metallic or textile strength members containing at least one novolac resin comprising alkyl urethane units and produced by reaction of a phenolic compound, an aldehyde and a carbamate resin, wherein the carbamate resin is produced by reaction of alkyl urethane with an aldehyde, and at least one etherified melamine resin. The invention further relates to a pneumatic vehicle tire which comprises at least one such sulfur-crosslinked rubberization mixture.

For improved durability of the rubberized strength members, the rubberization mixture contains
less than 2.5 phr (parts by weight, based on 100 parts by weight of the total rubbers in the mixture) of at least one novolac resin comprising alkyl urethane units and produced by reaction of a phenolic compound, an aldehyde and a carbamate resin, wherein the carbamate resin is produced by reaction of alkyl urethane with an aldehyde, and
less than 2.5 phr of at least one etherified melamine resin.

The invention relates to a sulfur-crosslinkable rubberization mixture for metallic or textile strength members containing at least one novolac resin comprising alkyl urethane units and produced by reaction of a phenolic compound, an aldehyde and a carbamate resin, wherein the carbamate resin is produced by reaction of alkyl urethane with an aldehyde, and at least one etherified melamine resin. The invention further relates to a pneumatic vehicle tire which comprises at least one such sulfur-crosslinked rubberization mixture.

In sulfur-crosslinkable rubber mixtures used as rubberization mixtures for textile strength members such as rayon, polyamide and polyester it is customary to employ so-called methylene acceptor-methylene donor pairs in order to achieve not only bonding via the sulfur network but also a compound for the adhesive impregnation of the textile strength member, generally an RFL dip. The RFL dip comprises resorcinol and formaldehyde or their precondensates.

Also marketed today as an alternative to RFL dips are maleic-functionalized polymers for treatment of textile fabric/textile strength members to achieve improved adhesion to rubber mixtures. Such so-called RF-free dips are disclosed for example in EP 1745079 B1 and DE 102014211365 A1.

Methylene donors/formaldehyde donors employed are for example hexamethoxymethylmelamine (HMMM) and/or hexamethylenetetramine (HMT). They are very commonly used in the tire industry. Employed methylene acceptors include resorcinol and resorcinol equivalents or precondensates thereof as well as other phenols. The methylene donor and the methylene acceptor form a resin during the vulcanization process. In addition to the sulfur network a second network based on the methylene donor and the methylene acceptor, which enters into adhesive interaction with the adhesive impregnation of the strength member, is formed.

The use of methylene acceptor-methylene donor pairs is also known for rubberization mixtures for metallic strength members, in particular brass-plated steel cord. In the so-called direct adhesion process for brass-plated steel cord the rubberization mixture contains for example cobalt salts and a resorcinol-formaldehyde-silica system, wherein the formaldehyde generally derives from formaldehyde donors such as etherified melamine resins. Etherified melamine resins include, for example, hexamethoxymethylmelamine (HMMM) and hexamethylenetetramine (HMT). Adhesion is also improved through the use of reinforcer resins and the mixtures should contain a lot of sulfur and less accelerator to allow sufficient mechanical keying with the steel cord surface.

Resorcinol-based methylene acceptors have disadvantages with regard to occupational health and environmental protection. Resorcinol has a relatively high vapor pressure at the use temperatures of a rubberization mixture, with the result that it undergoes partial evaporation and condensation on cooler components during use. This results in large-scale contamination and thus in demanding cleanup requirements for the use environment. Furthermore, resorcinol is classified as hazardous to health and harmful to the environment. It may affect the central nervous system. Efforts are therefore being made to dispense with resorcinol as a methylene acceptor.

Mixtures that dispense with methylene acceptors are known for example from EP 0 830 423 B1 and EP 2 065 219 A1. However, these documents employ so-called self-condensing alkylated triazine resins with high imino and/or methylol functionality, wherein it is assumed that the high imino and/or methylol functionality allows these resins to self-condense to form a network required for adhesion without any need for a methylene acceptor.

EP 2 674 452 A1 discloses using a reactive phenolic resin, in particular a phenolic resin modified with a vegetable and/or animal oil, an unsaturated oil and/or aromatic hydrocarbon, as a methylene acceptor in a sulfur-crosslinkable rubberization mixture for textile strength members in pneumatic vehicle tires. This results in good adhesion and less contamination during mixture production while simultaneously making it possible to dispense with health-hazardous and environmentally harmful resorcinol during use.

It has been found that the abovementioned methylene acceptors do not result in the desired adhesion and stiffness in all applications, in particular all tire body mixtures. Resorcinol residues are also often still present in the resins and entail the known hazards to health and the environment during their use.

EP 2 432 810 B1 relates to adhesion-improving rubberization mixtures for rubber articles containing at least one novolac resin, which comprises alkyl urethane units and is produced by reaction of a phenolic compound, an aldehyde and a carbamate resin, wherein the carbamate resin is produced by reaction of alkyl urethane with an aldehyde, and at least one etherified melamine resin. The mixtures should feature good hardness, tensile strength and adhesion while dispensing with resorcinol-based systems which are hazardous to health and the environment. The mixtures described in EP 2 432 810 B1 comprise 3 phr of a butyl carbamate-functionalized phenol-formaldehyde resin and 3 phr of hexamethoxymethylmelamine (HMMM).

It is an object of the invention to provide a sulfur-crosslinkable rubberization mixture which results in an improvement in terms of the durability of the rubberized strength member layers coupled with good or improved adhesion to strength members.

The object is achieved in accordance with the invention when the rubberization mixture contains
less than 2.5 phr (parts by weight, based on 100 parts by weight of the total rubbers in the mixture) of at least one novolac resin comprising alkyl urethane units and produced by reaction of a phenolic compound, an aldehyde and a carbamate resin, wherein the carbamate resin is produced by reaction of alkyl urethane with an aldehyde, and
less than 2.5 phr of at least one etherified melamine resin.

The unit “phr” (parts per hundred parts of rubber by weight) used in this document is the standard unit of quantity for mixture recipes in the rubber industry. The dosage of the parts by weight of the individual substances is always based here on 100 parts by weight of the total mass of all rubbers present in the mixture. The mass of all rubbers present in the mixture sums to 100.

It has surprisingly been found that such small amounts of the special novolac resin and the etherified melamine resin make it possible to obtain rubberization mixtures featuring improved tensile strength and elongation at break after vulcanization. This results in improved durability of the rubberized strength members and thus of the rubber products comprising these rubberized strength members. Such rubberization mixtures also make it possible to achieve a shorter vulcanization time.

According to an advantageous development of the invention the rubberization mixture contains
1.2 to 1.8 phr of at least one novolac resin comprising alkyl urethane units and produced by reaction of a phenolic compound, an aldehyde and a carbamate resin, wherein the carbamate resin is produced by reaction of alkyl urethane with an aldehyde, and
1.2 to 1.8 phr of at least one etherified melamine resin.

This makes it possible to achieve a marked improvement in the adhesion strength and the coverage between the strength member and the rubberization in adhesion tests. This ensures a good bond between the strength member and the embedding rubber in the rubber products.

In order to achieve particularly good results in terms of adhesion and stress-strain behavior it has proven advantageous when the proportions of the novolac resin and of the etherified melamine resin sum to less than 5 phr, preferably 2.5 to 3.5 phr.

The ratio of the novolac resin to the etherified melamine resin is preferably 1:1.5 to 1.5:1, particularly preferably 1:1.

If in accordance with an advantageous development the rubberization mixture is free from resorcinol as an adhesive the mixtures are also more environmentally friendly and less hazardous to health during use.

The novolac resin is produced by reaction of a phenolic compound with an aldehyde and a carbamate resin. The phenolic compound may be selected from the group consisting of phenol, o-, m- and p-cresol and o-, m- and p-monoalkylphenols with alkyl radicals having up to 18 carbon atoms. The phenolic compound is preferably phenol. The aldehyde may be selected from the group consisting of formaldehyde, acetaldehyde, propionaldehyde, butyraldehyde and isobutyraldehyde. The aldehyde is preferably formaldehyde.

The carbamate resin is produced by reaction of alkyl urethane with an aldehyde. The alkyl urethane may be selected from the group consisting of ethyl urethane, butyl urethane, 2-ethylhexyl urethane and decyl urethane. The alkyl urethane is preferably butyl urethane.

The aldehyde for the carbamate resin may be selected from the group consisting of formaldehyde, acetaldehyde, propionaldehyde, butyraldehyde and isobutyraldehyde. The aldehyde is preferably formaldehyde.

The aldehydes for the novolac resin and the carbamate resin may be identical or different aldehydes.

The rubberization mixture preferably employs a novolac resin produced from phenol, formaldehyde and a carbamate resin made from butyl urethane and formaldehyde (butyl carbamate-functionalized phenol-formaldehyde resin).

The rubberization mixture contains at least one etherified melamine resin which constructs a secondary network for good adhesion and hardness.

The etherified melamine resin is preferably hexamethoxymethylmelamine (HMMM). This is a customary commercially available melamine resin which forms a good resin network. HMMM is employed as a technical grade product for example—often on an inert carrier—with a degree of methylation of <6.

The sulfur-crosslinkable rubber mixture contains further constituents customary in the rubber industry, in particular at least one rubber.

Employable rubbers include diene rubbers. Diene rubbers include all rubbers having an unsaturated carbon chain which at least partially derive from conjugated dienes.

The rubber mixture may contain polyisoprene (IR, NR) as the diene rubber. This may be either cis-1,4-polyisoprene or 3,4-polyisoprene. Preference is given, however, to the use of cis-1,4-polyisoprenes with a cis-1,4 content>90% by weight. Such a polyisoprene is firstly obtainable by stereospecific polymerization in solution with Ziegler-Natta catalysts or using finely divided lithium alkyls. Secondly, natural rubber (NR) is one such cis-1,4-polyisoprene; the cis-1,4 content in the natural rubber is greater than 99% by weight. Natural rubber is understood to mean rubber that can be obtained by harvesting from sources such as rubber trees (Hevea brasiliensis) or non-rubber tree sources (for example guayule or dandelion (e.g. Taraxacum koksaghyz)).

If the rubber mixture contains polybutadiene (BR) as the diene rubber, this may be cis-1,4-polybutadiene. Preference is given to the use of cis-1,4-polybutadiene with a cis-1,4 content greater than 90% by weight, which can be prepared, for example, by solution polymerization in the presence of catalysts of the rare earth type.

Further diene rubbers that may be employed include vinyl-polybutadienes and styrene-butadiene copolymers. The vinyl-polybutadienes and styrene-butadiene copolymers may be solution-polymerized (styrene)-butadiene copolymers (S-(S)BR) having a styrene content, based on the polymer, of about 0% to 45% by weight and a vinyl content (content of 1,2-bonded butadiene, based on the total polymer) of 10% to 90% by weight, which may be produced using lithium alkyls in organic solvent for example. The S-(S)BR may also be coupled and endgroup-modified. However, it is also possible to employ emulsion-polymerized styrene-butadiene copolymers (E-SBR) and mixtures of E-SBR and S-(S)BR. The styrene content of the E-SBR is about 15% to 50% by weight, and it is possible to use the products known from the prior art that have been obtained by copolymerization of styrene and 1,3-butadiene in aqueous emulsion.

The diene rubbers used in the mixture, especially the styrene-butadiene copolymers, can also be used in partly or fully functionalized form. The functionalization can be effected with groups which can interact with the fillers used, especially with fillers bearing OH groups. These may be for example functionalizations with hydroxyl groups and/or epoxy groups and/or siloxane groups and/or amino groups and/or phthalocyanine groups and/or carboxy groups and/or silane sulfide groups. Alternatively or in addition the diene rubbers may also be coupled.

However, in addition to the recited diene rubbers the mixture may also contain other rubber types such as for example styrene-isoprene-butadiene terpolymer, butyl rubber, halobutyl rubber or ethylene-propylene-diene rubber (EPDM).

Regenerate (reclaim) may also be added to the rubber mixture as a processing aid and to make the mixture more cost-effective.

The rubber mixture may comprise different fillers, such as carbon blacks, silicas, aluminosilicates, chalk, starch, magnesium oxide, titanium dioxide or rubber gels, in customary amounts, where the fillers may be used in combination.

If carbon black is used in the rubber mixture, the types used are preferably those having a CTAB surface area (to ASTM D 3765) of more than 30 m²/g. These can be mixed in in a simple manner and ensure low buildup of heat.

If silicas are present in the mixture, they may be the silicas that are customary for tire rubber mixtures. It is particularly preferable when a finely divided, precipitated silica is used, having a CTAB surface area (to ASTM D 3765) of 30 to 350 m²/g, preferably of 110 to 250 m²/g. Silicas used may be either conventional silicas, such as those of the VN3 type (trade name) from Evonik, or highly dispersible silicas known as HD silicas (e.g. Ultrasil 7000 from Evonik).

If the rubber mixture contains silica or other polar fillers, silane coupling agents may be added to the mixture for improvement of processability and for binding of the polar filler to the rubber. The silane coupling agents react with the surface silanol groups of the silica or other polar groups during the mixing of the rubber/the rubber mixture (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sₓ— (with x=2-8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. The silane coupling agents may also be added here as a mixture with industrial carbon black, for example TESPT to carbon black (trade name: X50S from Evonik). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is possible to use, for example, silanes which are sold under the NXT name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

Furthermore, the rubber mixture according to the invention may comprise standard additives in customary proportions by weight. These additives include plasticizers, for example glycerides, factices, hydrocarbon resins, aromatic, naphthenic or paraffinic mineral oil plasticizers (for example MES (mild extraction solvate) or TDAE (treated distillate aromatic extract)), oils based on renewable raw materials (for example rapeseed oil, terpene oils (for example orange oils) or factices), so-called BTL oils (as disclosed in DE 10 2008 037714 A1) or liquid polymers (for example liquid polybutadiene); aging stabilizers, for example N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances, as known for example from J. Schnetger, Lexikon der Kautschuktechnik, 2nd edition, Hüthig Buch Verlag, Heidelberg, 1991, pages 42-48, activators, for example zinc oxide and fatty acids (for example stearic acid), waxes, tackifier resins, for example hydrocarbon resins and colophony, and mastication aids, for example 2,2′-dibenzamidodiphenyldisulfide (DBD).

When the strength member is a metallic strength member it has proven advantageous for improving the adhesion between the strength member and the rubberization when the rubberization mixture contains at least one organic cobalt salt. The organic cobalt salts are typically employed in amounts of 0.2 to 2 phr. Cobalt salts that may be used include for example cobalt stearate, borate, borate-alkanoates, naphthenate, rhodinate, octoate, adipate etc.

The vulcanization is conducted in the presence of sulfur and/or sulfur donors, and some sulfur donors can simultaneously act as vulcanization accelerators. Sulfur or sulfur donors are added to the rubber mixture in the amounts commonly used by those skilled in the art (0.4 to 8 phr) in the last mixing step. To improve adhesion, in particular to textile strength members, the rubberization mixture preferably contains less than 5 phr of sulfur.

In addition, the rubber mixture may comprise vulcanization-influencing substances such as vulcanization accelerators, vulcanization retarders and vulcanization activators in customary amounts, in order to control the time required and/or the temperature required in the vulcanization and to improve the vulcanizate properties. The vulcanization accelerators may, for example, be selected from the following groups of accelerators: thiazole accelerators, for example 2-mercaptobenzothiazole, sulfenamide accelerators, for example benzothiazyl-2-cyclohexylsulfenamide (CBS), benzothiazyl tert-butylsulfenamide (TBBS) and benzothiazyl dicyclohexylsulfenamide (DCBS), guanidine accelerators, for example N,N′-diphenylguanidine (DPG), dithiocarbamate accelerators, for example zinc dibenzyldithiocarbamate, disulfides, thiophosphates. The accelerators can also be used in combination with one another, which can give rise to synergistic effects.

It is also possible to use further network-forming systems, for example Vulkuren®, Duralink® or Perkalink®, or systems as described in WO 2010/049261 A2 in the rubberization mixture.

The vulcanization accelerators may be used in customary amounts. In an advantageous development of the invention the rubberization mixture contains as vulcanization accelerator 0.8 to 1.5 phr of benzothiazyl-2-dicyclohexylsulfenamide (DCBS) and less than 0.5 phr of other vulcanization accelerators. Improved results in terms of adhesion, in particular to metallic strength members, are achievable with DCBS as the vulcanization accelerator.

Production of the rubberization mixture according to the invention is carried out in conventional fashion, wherein it generally comprises initially producing a base mixture containing all the constituents with the exception of the vulcanization system (sulfur and vulcanization-influencing substances) in one or more mixing stages and subsequently producing the finished mixture by adding the vulcanization system. The mixture is then subjected to further processing.

The rubberization mixture may be employed in a very wide variety of rubber products containing strength members. These rubber products may include for example drive belts, conveyor belts, hoses, rubberized fabrics or air springs.

The rubberization mixture is preferably employed in pneumatic vehicle tires. It may be employed therein for example as a rubberization for textile or metallic strength members. The textile strength members may for example be made of aramid, polyester, polyamide, rayon or hybrid cords made of these materials.

The rubberization mixture may be employed for rubberization of a very wide variety of tire components such as the bead core, the bead covers, the bead reinforcers, the belt, the carcass or the belt bandages but the rubber mixture may also be used for other mixtures in proximity to strength members such as the apex, the squeegee, the belt edge pads, the shoulder pads, the undertreads or other body mixtures, wherein it is also possible for two or more components in a tire to be provided with the mixture according to the invention. The production of the pneumatic vehicle tires according to the invention is carried out according to processes known to those skilled in the art.

It is preferable when the rubberization mixture is employed as a carcass and/or bandage rubberization where the good tensile strength and the good adhesion values between the strength member and the rubberization mixture result in a long lifetime of the pneumatic vehicle tire.

Alternatively or in addition, the rubberization mixture may also be used as a belt rubberization mixture which in turn has a positive influence on the lifetime of the pneumatic vehicle tire.

The invention shall now be more particularly elucidated with reference to the tables which follow.

Tables 1 and 2 show example mixtures for different components of a pneumatic vehicle tire. Mixtures for a rubberization for steel cord are reported in table 1. Mixtures for a rubberization for textile strength members are reported in table 2.

In the mixtures of the tables the adhesive resorcinol was replaced with a novolac resin produced from phenol, formaldehyde and a carbamate resin made from butyl urethane and formaldehyde (butyl carbamate-functionalized phenol-formaldehyde resin) and the amounts thereof as well as those of HMMM were varied.

Mixture production was carried out under customary conditions to produce a base mixture and subsequently the finished mixture in a laboratory tangential mixer.

The conversion times for 90% conversion (t₉₀, complete vulcanization time) were determined using a rotorless vulcameter (MDR=moving disk rheometer) according to DIN 53 529 for vulcanization at 160° C.

The mixtures were used to produce test specimens by optimal vulcanization under pressure at 160° C., and these test specimens were used to determine material properties typical for the rubber industry by the test methods specified hereinafter.
Shore A hardness at room temperature according to DIN ISO 7619-1
Rebound resilience at 70° C. according to DIN 53 512
Tensile strength at room temperature according to DIN 53 504
Elongation at break at room temperature according to DIN 53504
Maximum (max) loss factor tan δ (tangent delta) from dynamic-mechanical measurement at 55° C. according to DIN 53 513, strain sweep

In addition, the mixtures from table 1 were used to conduct adhesion experiments on brass-plated steel cord (2×0.3 HT) according to ASTM 2229/D1871 without aging (vulcanization: 20 min, 160° C., embedding length in the rubberization mixture: 10 mm, pull-out speed: 125 mm/min). The pull-out force and coverage were determined. For the pull-out force, the value of mixture 1 was taken as 100%; the values of the other mixtures were based on mixture 1.

Adhesion tests, so-called peel tests, according to ISO 36:2011 (E) and DIN 53 530 with evaluation according to DIN ISO 6133 were conducted with the mixtures of table 2 on textile strength members made of polyester without aging. To this end, strength member cords made of polyester (1440×2 dtex) treated with RFL dip were covered with the unvulcanized rubber mixtures and then vulcanized at 160° C. for 20 minutes. Subsequently the force required to peel the mixture from the cords (adhesion strength) was determined and the coverage of the cords with mixture after peeling was visually ascertained (5: complete coverage, 1: no coverage). For the adhesion strength, the value of mixture 9 was taken as 100%; the values of the other mixtures were based on mixture 9.

TABLE 1

| Constituents | Unit | 1 | 2 | 3 | 4 | 5 | 6 | 7 | 8 |
|---|---|---|---|---|---|---|---|---|---|
| Natural rubber | phr | 100 | 100 | 100 | 100 | 100 | 100 | 100 | 100 |
| Carbon black | phr | 55 | 55 | 55 | 55 | 55 | 55 | 55 | 55 |
| Silica | phr | 15 | 15 | 15 | 15 | 15 | 15 | 15 | 15 |
| Plasticizers, | phr | 5 | 5 | 5 | 5 | 5 | 5 | 5 | 5 |
| aging | | | | | | | | | |
| stabilizers | | | | | | | | | |
| Vulcanization | phr | 10 | 10 | 10 | 10 | 10 | 10 | 10 | 10 |
| activators | | | | | | | | | |
| Cobalt stearate | phr | 1.3 | 1.3 | 1.3 | 1.3 | 1.3 | 1.3 | 1.3 | 1.3 |
| Resorcinol | phr | 3 | — | 2 | — | 1.5 | — | 1 | — |
| butyl carbamate- | phr | — | 3 | — | 2 | — | 1.5 | — | 1 |
| functionalized | | | | | | | | | |
| phenol- | | | | | | | | | |
| formaldehyde | | | | | | | | | |
| resin^{a)} | | | | | | | | | |
| HMMM^{b)} | phr | 4.61 | 4.61 | 3.08 | 3.08 | 2.31 | 2.31 | 1.54 | 1.54 |
| Accelerator DCBS | phr | 1.2 | 1.2 | 1.2 | 1.2 | 1.2 | 1.2 | 1.2 | 1.2 |
| Sulfur | phr | 6 | 6 | 6 | 6 | 6 | 6 | 6 | 6 |
| Properties | | | | | | | | | |
| t₉₀ | min | 8.1 | 11.7 | 8.4 | 10.2 | 8.5 | 9.4 | 8.3 | 8.8 |
| Hardness at RT | Shore | 76 | 78 | 74 | 75 | 75 | 75 | 71 | 71 |
| | A | | | | | | | | |
| Rebound | % | 49 | 49 | 51 | 51 | 50 | 49 | 52 | 51 |
| resilience at | | | | | | | | | |
| 70° C. | | | | | | | | | |
| Tensile strength | MPa | 16 | 17 | 18 | 18 | 17 | 19 | 19 | 20 |
| at RT | | | | | | | | | |
| Elongation at | % | 320 | 366 | 366 | 392 | 350 | 424 | 399 | 450 |
| break | | | | | | | | | |
| Pull-out force | % | 100 | 110 | 108 | 114 | 112 | 115 | 111 | 111 |
| (unaged) | | | | | | | | | |
| Coverage | % | 95 | 94 | 95 | 94 | 96 | 95 | 95 | 95 |
| (unaged) | | | | | | | | | |

^{a)}Alnovol ® PN 760/Past, Allnex Netherlands B.V.
^{b)}Hexamethoxymethylmelamine 65% on silica

The inventive steel cord rubberizations of table 1 show a marked improvement in elongation at break and an improvement in tensile strength when the amounts of butyl carbamate-functionalized phenol-formaldehyde resin and HMMM are reduced. This results in improved durability of the rubberized strength members and the products produced therefrom. Furthermore, the heating time t₉₀ can be reduced with smaller amounts of butyl carbamate-functionalized phenol-formaldehyde resin and HMMM, thus resulting in cost and time savings in the production of the products.

A rubberization mixture containing between 1.2 and 1.8 phr of butyl carbamate-functionalized phenol-formaldehyde resin and HMMM, as in mixture 6, also shows a particularly high adhesion strength coupled with high coverage, thus indicating particularly good bonding between the strength member and the embedded rubber.

TABLE 2

| Constituents | Unit | 9 | 10 | 11 | 12 | 13 | 14 |
|---|---|---|---|---|---|---|---|
| Natural rubber | phr | 50 | 50 | 50 | 50 | 50 | 50 |
| SBR | phr | 50 | 50 | 50 | 50 | 50 | 50 |
| Carbon black | phr | 55 | 55 | 55 | 55 | 55 | 55 |
| Silica | phr | 15 | 15 | 15 | 15 | 15 | 15 |
| Plasticizers, | phr | 5 | 5 | 5 | 5 | 5 | 5 |
| aging | | | | | | | |
| stabilizers | | | | | | | |
| Vulcanization | phr | 8 | 8 | 8 | 8 | 8 | 8 |
| activators | | | | | | | |
| Resorcinol | phr | 3 | — | 1.75 | — | 1.75 | — |
| butyl carbamate- | phr | — | 3 | — | 1.75 | — | 1.75 |
| functionalized | | | | | | | |
| phenol- | | | | | | | |
| formaldehyde | | | | | | | |
| resin^{a)} | | | | | | | |
| HMMM^{b)} | phr | 4.61 | 4.61 | 1.92 | 1.92 | 1.92 | 1.92 |
| Accelerator | phr | 1.2 | 1.2 | 1.2 | 1.2 | 1.2 | 1.2 |
| Sulfur | phr | 6 | 6 | 6 | 6 | 4.5 | 4.5 |
| Properties | | | | | | | |
| t₉₀ | min | 13.7 | 18.7 | 15.7 | 13.8 | 14.8 | 13.9 |
| Hardness at RT | Shore | 80 | 80 | 79 | 76 | 76 | 75 |
| | A | | | | | | |
| Rebound | % | 54 | 52 | 54 | 53 | 49 | 50 |
| resilience at | | | | | | | |
| 70° C. | | | | | | | |
| tan δₘₐₓ at 55° C. | — | 0.174 | 0.190 | 0.170 | 0.177 | 0.187 | 0.189 |
| Adhesion | % | 100 | 129 | 105 | 141 | 128 | 174 |
| strength | | | | | | | |
| (unaged) | | | | | | | |
| Coverage | — | 3.8 | 3.8 | 4 | 4.2 | 3.8 | 4.2 |
| (unaged) | | | | | | | |

^{a)}Alnovol ® PN 760/Past, Allnex Netherlands B.V.
^{b)}Hexamethoxymethylmelamine 65% on silica

In the rubberization of textile strength members too, amounts of 1.75 phr of butyl carbamate-functionalized phenol-formaldehyde resin and HMMM allow a marked improvement in adhesion and the heating times required for a conversion of 90% are markedly shortened. Mixture 12 additionally provides the advantage of a markedly reduced tan δₘₐₓ value, which is an indicator of a markedly reduced rolling resistance in rubber products such as tires. The adhesion strength can be further improved when the sulfur content is reduced to less than 5 phr (see mixture 14).

1.-14. (canceled)

15. A sulfur-crosslinkable rubberization mixture for metallic or textile strength members, the mixture comprising:
less than 2.5 phr (parts by weight, based on 100 parts by weight of the total rubbers in the mixture) of at least one novolac resin comprising alkyl urethane units and produced by reaction of a phenolic compound, an aldehyde and a carbamate resin, wherein the carbamate resin is produced by reaction of alkyl urethane with an aldehyde; and,
less than 2.5 phr of at least one etherified melamine resin.

16. The sulfur-crosslinkable rubberization mixture as claimed in claim 15, the mixture comprising:
1.2 to 1.8 phr of the at least one novolac resin comprising alkyl urethane units and produced by reaction of a phenolic compound, an aldehyde and a carbamate resin, wherein the carbamate resin is produced by reaction of alkyl urethane with an aldehyde; and,
1.2 to 1.8 phr of the at least one etherified melamine resin.

17. The sulfur-crosslinkable rubberization mixture as claimed in claim 15, wherein the novolac resin and the etherified melamine together are incorporated in an amount of less than 5 phr.

18. The sulfur-crosslinkable rubberization mixture as claimed in claim 17, wherein the novolac resin and the etherified melamine together are incorporated in an amount of from 2.5 phr to 3.5 phr.

19. The sulfur-crosslinkable rubberization mixture as claimed in claim 15, wherein the mixture is free from resorcinol.

20. The sulfur-crosslinkable rubberization mixture as claimed in claim 15, wherein the phenolic compound is phenol.

21. The sulfur-crosslinkable rubberization mixture as claimed in claim 15, wherein the alkyl urethane is butyl urethane.

22. The sulfur-crosslinkable rubberization mixture as claimed in claim 15, wherein the aldehyde is formaldehyde.

23. The sulfur-crosslinkable rubberization mixture as claimed in claim 15, wherein the at least one etherified melamine resin is hexamethoxymethylmelamine (HMMM).

24. The sulfur-crosslinkable rubberization mixture as claimed in claim 15, wherein the mixture contains at least one organic cobalt salt.

25. The sulfur-crosslinkable rubberization mixture as claimed in claim 24, wherein the mixture contains from 0.2 to 2 phr of the at least one organic cobalt salt.

26. The sulfur-crosslinkable rubberization mixture as claimed in claim 15, wherein the mixture contains, as a vulcanization accelerator, from 0.8 to 1.5 phr of benzothiazyl-2-dicyclohexylsulfenamide (DCBS).

27. The sulfur-crosslinkable rubberization mixture as claimed in claim 26, wherein the mixture contains less than 0.5 phr of any other vulcanization accelerators.

28. The sulfur-crosslinkable rubberization mixture as claimed in claim 15, wherein the mixture contains less than 5 phr of sulfur.

29. The sulfur-crosslinkable rubberization mixture as claimed in claim 15, wherein the novolac resin and the etherified melamine resin are incorporated into the mixture in a weight ratio of from 1:1.5 to 1.5:1.

30. The sulfur-crosslinkable rubberization mixture as claimed in claim 29, wherein the novolac resin and the etherified melamine resin are incorporated into the mixture in a weight ratio of 1:1.

31. A pneumatic vehicle tire comprising the sulfur-crosslinked rubberization mixture as claimed in claim 15.

32. The pneumatic vehicle tire as claimed in claim 31, wherein the pneumatic vehicle tire comprises a carcass rubberization composed of the sulfur-crosslinkable rubberization mixture.

33. The pneumatic vehicle tire as claimed in claim 31, wherein the pneumatic vehicle tire comprises a bandage rubberization composed of the sulfur-crosslinkable rubberization mixture.

34. The pneumatic vehicle tire as claimed in claim 31, wherein the pneumatic vehicle tire comprises a belt rubberization composed of the sulfur-crosslinkable rubberization mixture.
